(19) United States
(12) Patent Application Publication
(10) Pub. No.: US 2012/0025147 A1
(43) Pub. Date: Feb. 2, 2012

(54) METHOD FOR PREPARING UNIQUE COMPOSITION HIGH PERFORMANCE ANODE MATERIALS FOR LITHIUM ION BATTERIES

(75) Inventors: Hong-Li Zhang, Goleta, CA (US); Daniel E. Morse, Santa Barbara, CA (US)

(73) Assignee: THE REGENTS OF THE UNIVERSITY OF CALIFORNIA, Oakland, CA (US)

(21) Appl. No.: 13/254,402

(22) PCT Filed: Mar. 2, 2010
(86) PCT No.: PCT/US2010/025944

§ 371 Date: Sep. 1, 2011

Related U.S. Application Data
(60) Provisional application No. 61/156,774, filed on Mar. 2, 2009.

(51) Int. Cl. H01B 1/04; B01J 19/00

(52) U.S. Cl. 252/503; 422/112

(57) ABSTRACT

A novel method for preparing unique composition high-performance anode materials with high energy density, high power density, high stability, and excellent cyclability for electrochemical energy storage devices, in particular for lithium ion batteries, wherein this method and material circumvent and surpass the limitations of those methods and materials currently available.

### CROSS REFERENCE TO RELATED APPLICATIONS

This application claims the benefit under 35 U.S.C. Section 119(e) of co-pending and commonly assigned U.S. Provisional Patent Application Ser. No. 61/156,774, filed on Mar. 2, 2009, by Hong-Li Zhang and Daniel E. Morse, entitled “METHOD FOR PREPARING UNIQUE COMPOSITION HIGH PERFORMANCE ANODE MATERIALS FOR LITHIUM ION BATTERIES,” attorney's docket number 30794.307-US-P1 (2009-491-1).

This application is related to the following co-pending and commonly-assigned patent applications:

U.S. Utility patent application Ser. No. 11/737,087, filed on Apr. 18, 2007, by Daniel E. Morse, Birgit Schwenzer, John R. Gomm, Kristian M. Roth, Brandon Heiken, and Richard Brutchey, and entitled “BIOLOGICALLY INSPIRED SYNTHESIS OF THIN FILMS AND MATERIALS,” which application is a continuation in part under 35 U.S.C. Section 365 of PCT Patent Application Serial No. PCT/US05/37421, filed on Oct. 18, 2005, by Daniel E. Morse, Birgit Schwenzer, John R. Gomm, Kristian M. Roth, and Brandon Heiken, entitled “BIOLOGICALLY INSPIRED SYNTHESIS OF THIN FILMS AND MATERIALS,” and published on Dec. 28, 2006 as PCT International Patent Publication No. WO 2006/137915, which application claims priority under 35 U.S.C. Section 119 of U.S. Provisional Patent Application Ser. No. 60/620,147, filed on Oct. 18, 2004, by Kristian M. Roth and Daniel E. Morse, and entitled “BIOLOGICALLY INSPIRED SYNTHESIS OF THIN FILMS AND MATERIALS”;

### STATEMENT REGARDING FEDERALLY SPONSORED RESEARCH AND DEVELOPMENT

This invention was made with Government support under Grant No. DAAD19-03-D-0004 awarded by the Army Research Office. The Government has certain rights in this invention.

all of which applications are incorporated by reference herein.

### BACKGROUND OF THE INVENTION

1. Field of the Invention

This invention relates to materials for use in lithium (Li) ion batteries and other electrical storage devices, and methods for fabricating the materials, in particular a method for preparing unique composition high-performance anode materials with high energy density, high power density, high stability, and excellent cyclability for lithium ion batteries and other electrical storage devices.

2. Description of the Related Art

(Note: This application references a number of different publications as indicated throughout the specification by one or more reference numbers within brackets, e.g., [x]. A list of these different publications ordered according to these reference numbers can be found below in the section entitled “References.” Each of these publications is incorporated by reference herein.)

Rechargeable lithium ion batteries (LIBs) have been widely used in various portable electronic devices (cell phones, portable computers, MP3 players, digital cameras and a wide range of consumer electronic devices), because they exhibit meritoriously high voltage, high energy density, long lifespan, light weight, low self-discharge rate, and no memory effect [1]. Moreover, the potential application of LIBs as a vital component in hybrid electric vehicles (HEVs) or electric vehicles (EVs), which are central to the reduction of fossil fuel consumption and reduction of CO₂ emissions arising from transportation, has also been attracting extensive interest all over the world [2-4]. To meet the demand for LIBs having higher energy and power densities, researchers have focused on the development of novel electrode materials.

Currently, the anode (negative electrode) materials in commercial LIBs are still mainly produced from graphite (e.g., mesophase carbon microbeads, known as MCMB). However, the theoretical capacity (372 milliamps hours/gram (mAh/g)) of graphite is relatively low, which has limited further improvement of LIB performance. Therefore, some non-carbonaceous materials with high theoretical capacity that can alloy with lithium, for example Si, Sn, Al, Sb, Zn, and Pb (referred to as lithium-alloying materials or components hereafter), are being studied extensively [5].

However, there is a severe drawback to the use of the lithium-alloying materials mentioned above: the volume changes of these materials during alloying/dealloying with lithium are so large that they typically cause the anodes to disintegrate, and finally lose mechanical and electrical contact with the bulk electrode. As a result, these materials inevitably display a poor cyclability when used as anode materials; that is, the electrical capacity shows progressive deterioration with multiple cycles of charging and discharging. To overcome this problem, many strategies have been proposed, including the use of composites in which one component (e.g., C, Cu, Ag, Ti, TiN, TiB₂, SiO₂, etc.) acts as a resilient matrix to buffer the large volume changes of the lithium-alloying component (e.g. Si, Sn, Sb) [6-8]. Other strategies include reducing the particle sizes of the lithium-alloying component to the nanometer scale [5,9], and utilizing intermetallic compounds (SnSb, SnAg, Sn₂Fe, etc.) or oxides (SnO₂, SnO, PbO, etc.) [10-12].

Among these strategies, constructing composites with carbonaceous materials (generically referred to as carbon hereafter) as the resilient matrix appears most promising for improvement of overall electrochemical performance (long-term cyclic stability, reversible capacity, and Coulombic efficiency). Thus, the key technological challenge is the synthesis of a composite in which a high density of a high-capacity lithium-alloying material can be highly dispersed within a resilient matrix of carbon.

Currently, two methods have been under intensive investigation and use: (i) high-energy ball milling (HEBM) [13] and (ii) chemical reduction (or electroless coating) [14-15]. For HEBM, the crystal structure of the carbon matrix is unavoidably destroyed when the mixture of lithium-alloying materials and carbon is milled together. Consequently, the Coulombic efficiency of the resulting composite is generally lowered.

For chemical reduction, reducing agents are directly added in liquid form to precursor solutions containing the components of lithium-alloying materials and carbon. When added dropwise, this addition of reductant causes the reaction to occur only in the local environment around the droplet, where the nucleating supersaturation is high enough to cause very rapid reaction kinetics. Despite the use of mechanical stirring, the resulting rapid kinetics and locally high supersaturation make it difficult to control the dispersion, uniformity and particle size of the lithium-alloying materials within the final composite.

Furthermore, except when using a pre-existed carbon matrix as described immediately above, some organic compounds that can be transformed to hard carbon under high temperature, such as phenolic resin and sugar, are also utilized together with the precursors of lithium-alloying materials to obtain a composite [16]. But this composite generally displays a low Coulombic efficiency and a sloping voltage profile, which are not favorable for practical application in LIBs.

### SUMMARY OF THE INVENTION

The present invention comprises a novel method for preparing unique composition, high performance, anode materials for LIBs with high reversible electrical capacity, excellent cyclability and high power capability, wherein lithium-alloying materials on the nanometer scale are catalytically grown in situ to become widely and thoroughly dispersed within a resilient matrix of carbon. This method and material circumvent and surpass the limitations of those materials and methods currently available.

The lithium-alloying materials in the present invention include, but are not limited to, the metals and metalloids (semi-metals) Sn, Si, Pb, Sb, Ge, Al, Bi, In, Ga, Cd, Zn, Mg, and As.

The carbon in the present invention is natural graphite, synthetic graphite, soft carbon, hard carbon, coke, carbon nanotubes, exfoliated graphite, graphene, chemically treated graphite, carbon nanotubes, graphene, related materials, or a mixture thereof.

The method in the present invention is based on a simple two-step procedure involving a biologically inspired vapor-diffusion catalysis followed by in situ carbothermal reduction. Before the in situ carbothermal reduction, an extra process of polymer surface-coating can also be utilized.

Thus, to overcome the limitations in the prior art described above, and to overcome other limitations that will become apparent upon reading and understanding the present specification, the present invention discloses a method for fabricating a composite material useful in an anode of a lithium ion battery, comprising (a) selecting a metal or metalloid capable of alloying with lithium; (b) combining together: (i) water, or an organic solvent, or a mixture thereof, (ii) the metal or metalloid capable of alloying with lithium, wherein the metal or metalloid is in a precursor compound capable of reacting in a hydrolysis reaction while in the solvent, and (iii) a carbon crystalline, amorphous or porous structure comprising a carbon matrix, so as to form a composition; (c) vapor diffusing a catalyst into the composition, wherein the catalyst is capable of inducing the hydrolysis of the metal or metalloid precursor compound to produce an oxide or oxohydroxide of the metal or metalloid from the precursor compound, so as to form metal oxide, metalloid oxide, metal oxohydroxide, or metalloid oxohydroxide nanoparticles that grow in situ within the carbon matrix, the nanoparticles thereby becoming well and/or widely and thoroughly distributed within the carbon matrix; and (d) performing a reduction reaction, catalyzed by carbon in the carbon matrix, that reduces the nanoparticles to their corresponding metal or metalloid within the carbon matrix, so as to form a composite of the nanoparticles well and/or widely and thoroughly distributed within the carbon matrix; so that the composite material useful in an anode of a lithium ion battery is made.

The reduction reaction may be a carbothermal reaction, and the method may further comprise performing a surface modification of the carbon matrix by surface-coating the carbon matrix with one or more polymers, before performing the reduction reaction of step (d); and performing a polymer pyrolysis, wherein the polymers on the surface of the carbon matrix are pyrolyzed to produce a residual carbon coating on the surface during the subsequent carbothermal reduction, so as to form a surface-modified composite of nanoparticles well and/or widely and thoroughly distributed widely within the carbon matrix.

The reduction reaction may be performed by carbothermal reduction, by heating the carbon matrix and the nanoparticles within the carbon matrix. The carbothermal reduction may be performed by heating at a temperature between 300° C. and 1800° C. The carbothermal reduction may strengthen an interfacial contact between the nanoparticles and the carbon matrix.

The precursor compound may be a salt, conjugate, chelate, or molecular complex of the metal or metalloid, dissolved in the water or the organic solvent so as to form a precursor solution, and the carbon matrix is suspended in the precursor solution.

The catalyst may be a molecule comprising catalyst dimensions and properties that enable the molecule to be delivered by vapor diffusion. The catalyst may be ammonia or hydrogen chloride.

The metal may be Sn and the salt may be SnCl₂. The metalloid may be Si and the precursor may be SiCl₄ and/or Si(OC₂H₅)₄, for example.

The vapor diffusion of the catalyst may enable the hydrolysis of the precursor in solution to cause a growth of the nanoparticles, in situ within the carbon matrix, thereby causing the nanoparticles to become well and/or widely and thoroughly distributed within a compliant and conductive carbon matrix.

Controlling the vapor diffusion of the catalyst may enable a growth of the nanoparticles that is sufficiently slow, such that the nanoparticles have dimensions sufficiently small, and a spatial distribution, in order that the nanoparticles are well and/or widely and thoroughly distributed throughout the carbon matrix.

The method may further comprise drying the nanoparticles and the carbon matrix prior to performing step (d).

The method may further comprise adjusting a concentration of the precursor solution and the catalyst, so that kinetics of both the vapor diffusion of the catalyst and the hydrolysis of the precursor in solution are modulated both to control the size of the nanoparticles and to enhance formation of the nanoparticles well and/or widely and thoroughly distributed within the carbon matrix.

The vapor diffusion step may further comprise placing the precursor solution and the carbon matrix in a first container and placing the catalyst in a second container separate from the first container, wherein the first container and second container are placed in a closed environment.

The method may further comprise adjusting a temperature and pressure in the closed environment, and stirring, sonicating, nebulizating (nebulization of), or vibrating the precursor solution, so that kinetics of both the vapor diffusing of the catalyst and the hydrolysis of the precursor in solution are modulated both to control the size of the nanoparticles and to enhance the formation of the nanoparticles well and/or widely and thoroughly distributed within the carbon matrix.

The hydrolysis reaction, catalyzed by the vapor diffusion, may form the nanoparticles with dimensions small enough so that the nanoparticles may penetrate between carbon atomic planes or intrinsic pores of the carbon matrix.

The carbon matrix may comprise one or more of the following: natural graphite, synthetic graphite, soft carbon, hard carbon, coke, carbon nanotubes, exfoliated graphite, graphene, chemically treated graphite, carbon nanotubes, graphene, related materials, or a mixture thereof.

The metals or metalloids capable of alloying with lithium may be selected from a group consisting of (but not limited to) Sn, Si, Pb, Sb, Ge, Al, Bi, In, Ga, Cd, Zn, As, and Mg.

The polymers used for the surface modification may be selected from a group consisting of (but not limited to) polyethylene (PE), polystyrene (PS), polyvinyl alcohol (PVA), polypropylene(PP), polyvinyl chloride(PVC), polyacrylonitrile (PAN), polyvinylpyrrolidone (PVP), and phenol formaldehyde resin (Bakelite).

The polymer pyrolysis and the carbothermal reduction reaction may be completed in one heating step. The one heating step may be at a temperature between 300° C. and 1800° C.

The present invention further discloses a composite material useful in an anode of a lithium ion battery, comprising metal or metalloid nanoparticles well and/or widely and thoroughly distributed within a carbon matrix having a crystalline, amorphous, or porous structure.

The nanoparticles may have a diameter less than 500 nanometers (nm).

An interfacial contact between the carbon matrix and the metal or metalloid nanoparticles of the composite material may be sufficiently strong so that a reversible electrochemical capacity of the anode does not significantly decrease as a number of cycles of charging and discharging of the lithium battery is increased during a lifetime of the battery.

A content of the metal or metalloid nanoparticles in the composite material may be in a range of 5 to 50 weight percentage (wt. %).

The composite material may further include a “polymer-derived carbon” coated on a surface of the composite material, to form a surface-modified composite or surface-modified form of the composite material. A content of the “polymer-derived carbon” in the composite material may be in a range of 2 to 40 wt. %. The surface-modified composite with the “polymer-derived carbon” coated on the surface may have a core-shell structure. The core-shell structure may comprise a shell and a core, wherein the core comprises the metal or metalloid nanoparticles well and/or widely and thoroughly distributed within the carbon crystalline, amorphous, or porous carbon matrix, and the shell comprises the “polymer-derived carbon” on the surface of the composite material.

The crystalline, amorphous, or porous carbon matrix may be sufficiently resilient or compliant to accommodate a volume change in the metal or metalloid nanoparticles that results from the metal or metalloid nanoparticles alloying and de-alloying with lithium during a plurality of charge and discharges of the lithium ion battery.

The present invention further discloses an apparatus for fabricating a composite material useful in an anode of a lithium ion battery, comprising: a sealable chamber; a first container, inside the sealable chamber, for containing a precursor solution or compound, wherein a first opening in the first container is for receiving a vapor diffused catalyst; a second container, inside the sealable chamber, for containing a catalyst, wherein a second opening in the second container is for allowing the catalyst in vapor diffused form to escape from the second container; a pump and pressure sensor, for controlling a pressure in the sealable chamber; one or more heating elements, for controlling a temperature of the sealable chamber; an opening in the first container for introducing a first solvent or precursor into the first container and adjusting a concentration of the precursor solution; an opening in the second container for introducing a second solvent or additional catalyst into the second container and adjusting a concentration of the catalyst; and a flow meter and fan or pump that controls a flow rate of the vapor diffused catalyst.

The method, composition, and apparatus of the present invention is not limited to use in, or fabrication of, anodes and/or batteries. The present invention may be useful in other applications.

### BRIEF DESCRIPTION OF THE DRAWINGS

Referring now to the drawings in which like reference numbers represent corresponding parts throughout:

FIG. 1 is a schematic diagram of the bio-inspired vapor-diffusion catalysis process according to the present invention, wherein reaction temperature, solution concentration, and chamber pressure are examples of kinetically controlling factors that influence the vapor diffusion of ammonia (NH₃) and the hydrolysis of precursor in solution.

FIGS. 2a and 2b show scanning electron microscopy (SEM) images (scale is 10 micrometers (μm)) of the original carbon (C; in this case, natural graphite) and an Sn@C composite with 5 wt. % Sn, respectively, wherein the composites fabricated by the method of the present invention are referred to in the format of “lithium-alloying materials@carbon,” and to indicate the difference, those composites fabricated by other methods are referred to as “lithium-alloying materials/carbon”.

FIG. 2c is a back-scattered electron image of the Sn@C composite in FIG. 2b. FIG. 2d shows the energy dispersive X-ray (EDX) mapping of Sn within the Sn@C composite in FIG. 2b.

FIG. 3 shows the X-ray diffraction (XRD) pattern of the Sn@C composite (5 wt. % Sn), plotting intensity of the XRD in arbitrary units (a.u.) as a function of angle 2θ.

FIG. 4 shows the comparison of electrochemical cyclic performance for the original carbon and the Sn@C composite (5 wt. % Sn), plotting capacity in mAh/g versus cycle numbers for the Sn@C (filled squares) and the carbon (hollow squares).

FIGS. 5a (scale is 5 μm) and 5b (scale is 2 μm) show SEM images of the Sn@C composite (15 wt. % Sn).

FIG. 5c shows the XRD pattern of the Sn@C composite (15 wt. % Sn), plotting intensity of the XRD in a.u. versus angle 2θ for the carbon (hollow triangles) and the Sn (filled triangles).

FIG. 5d shows the comparison of Raman spectra for the original carbon and the Sn@C composite (15 wt. % Sn), plotting intensity in a.u. versus wavenumber (cm⁻¹) for the Sn@C (lighter curve) and for the carbon (darker curve).

FIG. 6 shows the electrochemical cyclic performance for the Sn@C composite (15 wt. % Sn), plotting capacity (mAh/g) versus cycle numbers.

FIG. 7 shows voltage profiles of the original carbon and the Sn@C composite (15 wt. % Sn), plotting Voltage (V versus Li/Li⁺) versus capacity (mAh/g) for the Sn@C (dark circles) and the carbon (hollow squares), for charge and discharge.

FIG. 8 shows an SEM image (scale is 5 μm) of the Sn/C composite (15 wt. % Sn) fabricated by direct addition of ammonia into the mixture of Sn precursor solution and carbon, rather than by vapor-diffusion (as illustrated in FIGS. 1, 2a, 2b, 5a and 5b).

FIG. 9 shows the electrochemical cyclic performance of the Sn/C composite (15 wt. % Sn) fabricated by the direct addition of ammonia, plotting capacity in mAh/g versus cycle numbers.

FIG. 10 illustrates (scale is 5 μm) a surface-modified form of the composite material.

FIG. 11 shows the super-high rate capacity and full recovery of the surface-modified Sn@C composite (5 wt. % Sn), plotting capacity in mAh/g versus cycle number, wherein the 0.1 C, 0.5 C, 1 C, 1.5 C, 2 C, 5 C, 10 C, 20 C, and 50 C positions are shown and n C is a measure of the rate of discharge, which is completed in 1/n hours.

FIG. 12 shows the stable cyclability of this surface-modified Sn@C composite at the rates of 1 C (darker circles) and 2 C (lighter circles), wherein n C is a measure of the rate of discharge, which is completed in 1/n hours.

FIG. 13 shows the flat and stable voltage profiles of this surface-modified composite at different discharge rates, plotting Voltage (V versus Li/Li⁺) versus capacity in mAh/g, wherein the curves, from left to right, are for the discharge rates of 20 C, 10 C, 5 C, 2 C, 1 C, and 0.5 C, respectively.

FIG. 14 shows electrochemical cyclic performance of the surface-modified Sn@C composite at the rate of 1 C for both charge and discharge, plotting Capacity (mAh/g) vs. Cycle number.

FIG. 15 is a flowchart illustrating a method of the present invention.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Overview

The present invention discloses a low-temperature, facile synthesis of a unique composition, high performance, electrode material for LIBs with higher electrical capacity, better cyclability, better lifetime, and better power capability than present commercial batteries, potentially offering higher energy and power densities and longer lifetime than present commercial batteries. This method and material circumvent and surpass the limitations of methods and materials currently available. Potential uses range from portable electronic devices, computers, communicators and cell-phones, to all-electric and hybrid-electric vehicles, electrical tools and some special applications needing super-high performance batteries.

Technical Description

The anode materials of the present invention comprise lithium-alloying materials and carbon, wherein the lithium-alloying materials are nanometer-scale particles, typically <500 nanometers (nm) widely and thoroughly dispersed within the matrix of carbon.

In one embodiment, the lithium-alloying materials in the present invention include Sn, Si, Pb, Sb, Al, Bi, In, Ga, Cd, Zn, As, and Mg. In another embodiment, the carbon in the present invention is natural graphite, synthetic graphite, soft carbon, hard carbon, coke, carbon nanotubes, exfoliated graphite, graphene, chemically treated graphite, carbon nanotubes, graphene, or related materials, or a mixture thereof.

The method of preparing the composite anode materials in the present invention is a simple two-step procedure involving a biologically inspired vapor-diffusion catalysis followed by in situ carbothermal reduction.

In the method of the invention, fabrication begins with a precursor solution containing both a salt, molecular conjugate, chelate or complex of any of the above-named lithium-alloying materials, and the carbon. The molar ratio of the salts and the carbon influences the wt. % of lithium-alloying materials in the final composite.

In one embodiment, the salts, molecular conjugates, chelates, or complexes of lithium-alloying materials in the precursor solution can be chlorides, nitrates, sulfates, and organometallic compounds such as SnCl₂, SnCl₄, Si(OC₂H₅)₄, Al(NO₃)₃, MgSO₄, C₄H₁₂Sb, C₄H₆O₄Sn, C₄H₆O₄Sb, SnSO₄, Pb(NO₃)₂, MgCl₂, Al₂(SO₄)₃, AlCl₃, Zn(NO₃)₂, ZnCl₂, C₁₆H₃₀O₄Sn. In another embodiment, the solvent in the precursor solution can be water, or organic liquids (methanol, ethanol, acetone, tetrahydrofuran, ethylene glycol, etc.), or a mixture thereof.

In the method of the invention, a catalyst is delivered by vapor-diffusion into the precursor solution. In particular, the catalyst can induce hydrolysis of the salts, molecular conjugates, chelates, or complexes of the lithium-alloying materials. In one embodiment, the catalyst is a diffusible small molecule such as ammonia or hydrogen chloride.

In the method of the invention, the precursor solution and carbon are placed in a closed environment, and then the catalyst is introduced via the vapor phase into said closed environment.

In one embodiment, the closed environment comprises an air or inert gas (N₂, Ar, He, etc.) environment. In another embodiment, the temperature in the closed environment can be chosen in the range of 5 to 95° C. In a further embodiment, the reaction time in the closed environment is in the range of 5 to 600 minutes (min.).

Through adjusting the temperature and pressure in the closed environment and the concentration of precursor solution and catalyst, the kinetics of both the vapor diffusion of catalyst and the hydrolysis of precursor in solution can be correspondingly modulated. Furthermore, mechanical and/or ultrasonic stirring and vibration may be employed to improve homogeneity of the precursor solution and accelerate the rate of hydrolysis.

After the reaction in the closed environment, the precursor solution is filtered and the as-obtained composite is washed using deionized water and dried in vacuum or air. Finally, the resulting product (called “dried product” hereafter) is a composite comprising of the oxides, or oxo-hydroxides of the lithium-alloying materials, and the carbon, which composite is subsequently subjected to in situ carbothermal reduction.

In the method of the invention, the carbothermal reduction is performed in a heating furnace. In one embodiment, the temperature of the furnace is chosen in the range of 300 to 1800° C. In another embodiment, the atmosphere inside the furnace is N₂, Ar, He, or H₂, or a mixture thereof. In a further embodiment, the heating time of the furnace is in the range of 0.5 to 24 hours (h).

In the method of the invention, surface modification can be used to process the above “dried product” before the in situ carbothermal reduction. The surface modification is performed by first homogeneously dispersing the “dried product” in a solution of polymer, and then evaporating the said solution to obtain a polymer-coated product. The resulting polymer-coated product can then be subjected to carbothermal reduction as described immediately above for the “dried product”.

In the method of the invention, the polymer is one that can be pyrolyzed by the thermal treatment used for carbothermal reduction to produce a residual carbon coating (this residual carbon coating is designated “polymer-derived carbon” hereafter). In one embodiment, the polymer can include polyethylene (PE), polystyrene (PS), polyvinyl alcohol (PVA), polypropylene(PP), polyvinyl chloride(PVC), polyacrylonitrile (PAN), polyvinylpyrrolidone (PVP), and phenol formaldehyde resin (Bakelite), etc.

In the method of the invention, the solvents used for solution of the polymers can be water, methanol, ethanol, acetone, and tetrahydrofuran, etc.

In the method of the invention, the temperature to evaporate the solution of the polymers is in the range of 50 to 200° C.

In the present invention, the particle size and content of lithium-alloying materials in the final composite are less than 500 nm and in the range of 5 to 50 wt. %, respectively. The content of the “polymer-derived carbon” can be in the range of 2 to 40 wt. % in the final composite.

The unique aspects of the invention are as follows:
(i) The catalyst is introduced into the precursor solution by vapor diffusion, which is completely different from the conventional dropwise or bulk liquid addition. The vapor of catalyst diffuses into the precursor solution and the porous, suspended particles of the carbon matrix, via the gas/liquid interface, and thus affects the entire environment in the vicinity of the interface. In this method, the entire (non-local) environment simultaneously reaches supersaturation with catalyst sufficient to drive the hydrolysis of the metal or metalloid salt, conjugate, chelate, or molecular complex precursor solution. Moreover, the rate and concentration of supersaturation can easily be tuned by influencing the speed of vapor diffusion of catalyst by adjusting its temperature, initial concentration and pressure. As a result, the reaction kinetics in the hydrolysis of precursor in solution are highly controlled, thus providing a high degree of control over the dispersion and particle size of the resulting lithium-alloying materials in the resulting composite. Inspiration for this kinetic control is derived from observations that biological organisms can synthesize a variety of inorganic materials with precise regulation of nanostructure by control of the governing reaction kinetics, as cited in the above-cited patent applications incorporated by reference.
(ii) The in situ carbothermal reduction contributes to strengthen the interfacial contact between the lithium-alloying materials and the carbon, thereby contributing favorably to the improvement of cyclability of the composite anode materials.
(iii) The crystal structure and porosity of carbon are not be destroyed by the fabrication process described. This is beneficial for the retention of Coulombic efficiency of the composite anode materials.
(iv) The two processes of polymer pyrolysis and carbothermal reduction can be completed in one heating step. This significantly reduces time and energy consumption, especially important for industrial large-scale production.

The following examples further illustrate the present invention.

### Example 1

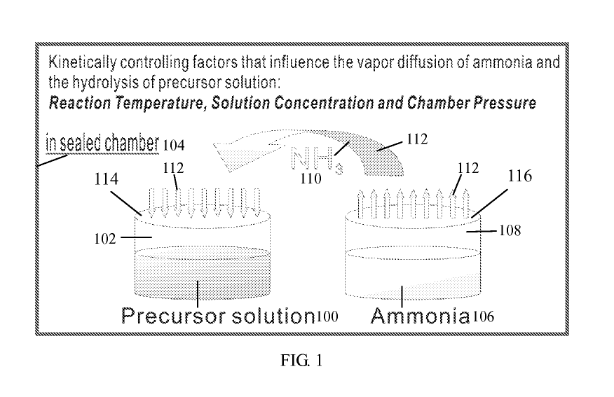

Natural graphite spheres (0.3 g, average particle size of 20 μm) were added to an aqueous solution of SnCl₂ (15 mL, 0.2 M) to form a precursor solution. After ultrasonic stirring for 30 min.), the precursor solution [100] was transferred to an open container [102] in a sealed chamber [104], where an aqueous solution of ammonia (2 wt. %) [106] was placed in another separate, open container [108] as shown in FIG. 1. At room temperature, the ammonia vapor [110] gradually diffused [112] into the precursor solution [100] that is under continuous mechanical stirring. After 30 min., the precursor solution [100] was removed from the sealed chamber [104] and filtered. The collected solid was washed with deionized water, and further dried at 80° C. in air.

The dried product was subjected to carbothermal reduction in a heating furnace. The temperature for carbothermal reduction was 950° C. The heating rate of the furnace from room temperature to 950° C. was 10° C./min., and N₂ was used as a protective gas atmosphere inside the furnace. After carbothermal reduction for 30 min., the furnace was allowed to cool to room temperature.

The final product was a Sn@C composite with Sn content of 5 wt. %.

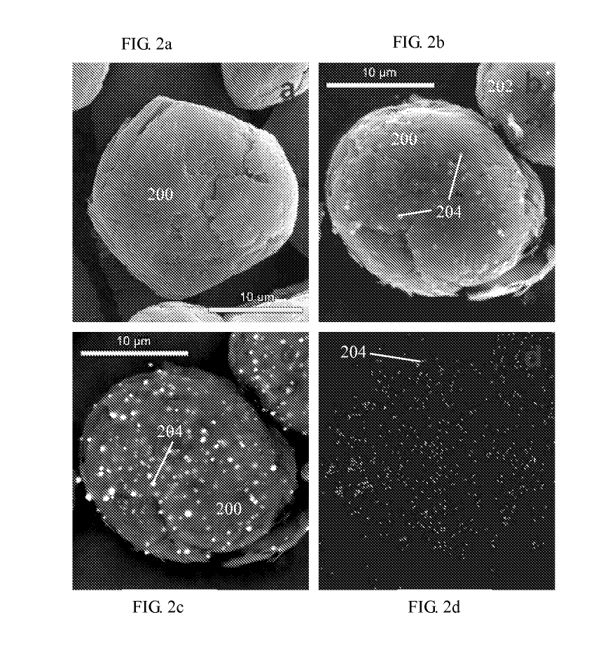

As seen in FIG. 2a, the natural graphite spheres [cf. 200 in FIG. 2a] to form the precursor solution comprised 0.3 g, with an average natural graphite sphere [200] size (diameter) of 20 μm.

As seen in FIGS. 2b-d, the composite [202] comprises Sn particles [204] of 200-500 nm diameter and well dispersed within the matrix of natural graphite spheres [200].

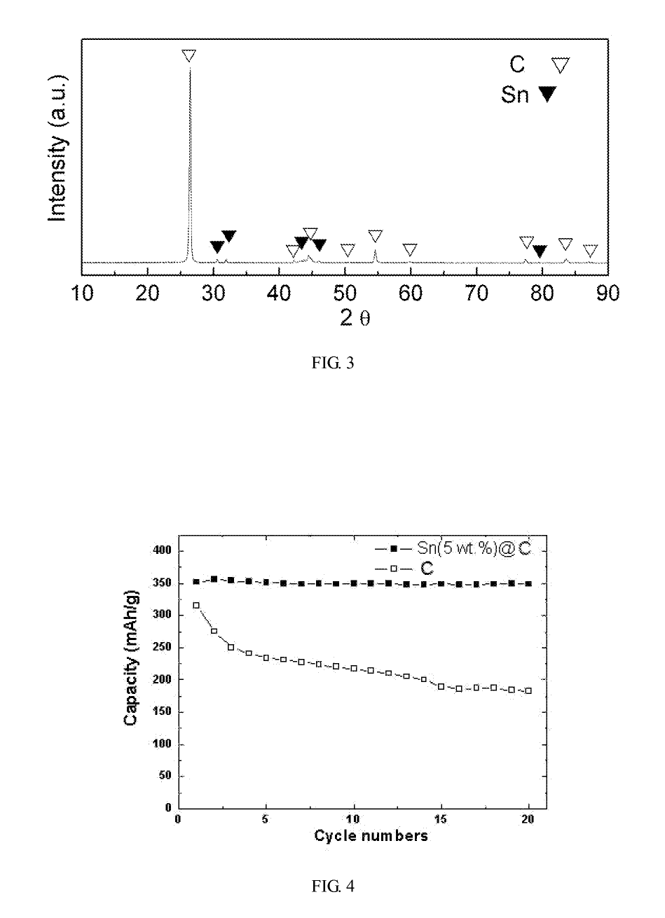

The XRD pattern in FIG. 3 indicates that the natural graphite spheres in the composite still retain the highly crystalline structure of the original graphite.

The electrochemical performance of the Sn@C composite as anode material for LIBs was measured using a standard half-cell method. Half-cells were assembled in an Ar-filled glove box (Unilab, H₂O and O₂<1 ppm) with a working electrode, a lithium foil counter electrode, and a porous separator (Celgard 2400). The working electrode was prepared by coating a slurry of the composite of the present invention (85 wt. %), carbon black (5 wt. %), and poly(vinylidene fluoride) binder (10 wt. %) dissolved in N-methylpyrrolidine onto a copper foil, and then drying in vacuum at 120° C. for 12 hours. Afterwards, the working electrode was cut into sheets with an area of 0.64 cm², and the sheets compressed under a pressure of 3 MPa. The electrolyte was 1 M LiPF₆ in a mixture of ethylene carbonate and dimethyl carbonate (1:1 by volume). The cells were galvanostatically charged/discharged at 0.1 C between 0.001 and 2.5 V versus Li⁺/Li, wherein C-Rate is used to signify a charge or discharge rate equal to the capacity of a battery divided by 1 hour, a rate of 0.1 C means transfer of all of the capacity in 10 hours, and in electrochemistry the voltages (0.001 and 2.5 V) are referred to the electrode potential of the Li⁺/Li couple.

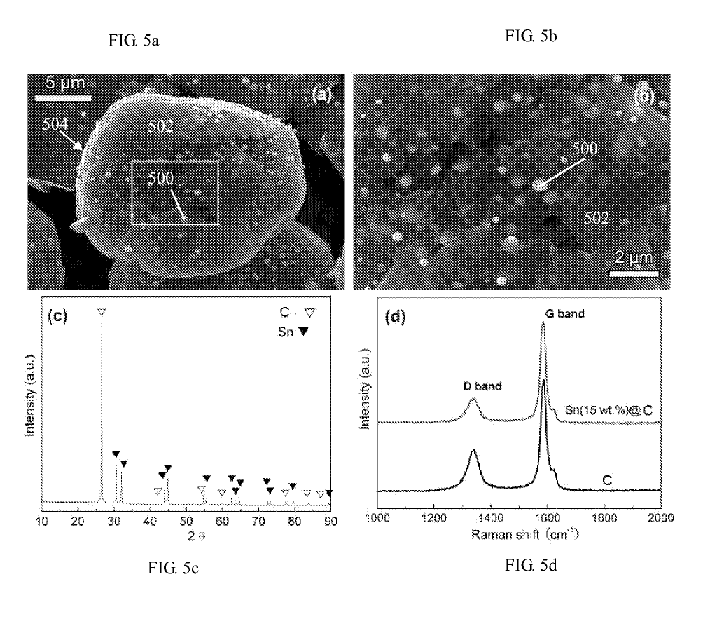

FIG. 4 displays the electrochemical cyclic performance of the composite through multiple cycles of charging and discharging, in which it can be seen that the composite has a very stable cyclability with a reversible capacity of ˜350 mAh/g.

### Comparative Example 1

The original natural graphite spheres (without Sn) were directly used as anode materials for LIBs, and their electrochemical performance was measured in the same way as for the Sn@C composite in Example 1. FIG. 4 shows the comparison of cyclic performance for the original natural graphite and the Sn@C composite with Sn content of 5 wt. %. It can be seen that the composite obtained by the method of the present invention is significantly superior to the original unmodified natural graphite.

### Example 2

Natural graphite spheres (0.5 g, average particle size of 20 μm, see FIG. 2a,) were added to an aqueous solution of SnCl₂ (15 mL, 0.2 M) to form a precursor solution. After ultrasonic stirring for 30 min., the precursor solution [100] was transferred to an open container [102] in a sealed chamber [104], where an aqueous solution of ammonia (2 wt. %) [106] was placed in another separate, open container as shown in FIG. 1. At 55° C. (rather than at room temperature, as in Example 1), the ammonia vapor [110] gradually diffused [112] into the precursor solution that was under continuous mechanical stirring. After 30 min., the precursor solution [100] was removed from the sealed chamber [104] and filtered. The collected solid was washed with deionized water, and further dried at 80° C. in air.

The dried product was subjected to carbothermal reduction in a heating furnace. The temperature of carbothermal reduction was selected to be 950° C. The heating rate of furnace from room temperature to 950° C. was 10° C./min, and N₂ was used as protective gas atmosphere inside the furnace. After carbothermal reduction for 30 min., the furnace was allowed to cool to room temperature.

The final product was a Sn@C composite with Sn content of 15 wt. %. As seen in FIGS. 5a-b, Sn particles [500] of 200-500 nm diameter are well dispersed within the matrix of natural graphite spheres [502]. The XRD pattern in FIG. 5c indicates that the natural graphite spheres [502] in the composite [504] still retain the highly crystalline graphite structure. Furthermore, the comparison of Raman spectra (see FIG. 5d) for the original natural graphite and the Sn@C composite also proves that the crystal structure of natural graphite spheres [502] is not destroyed by the fabrication process.

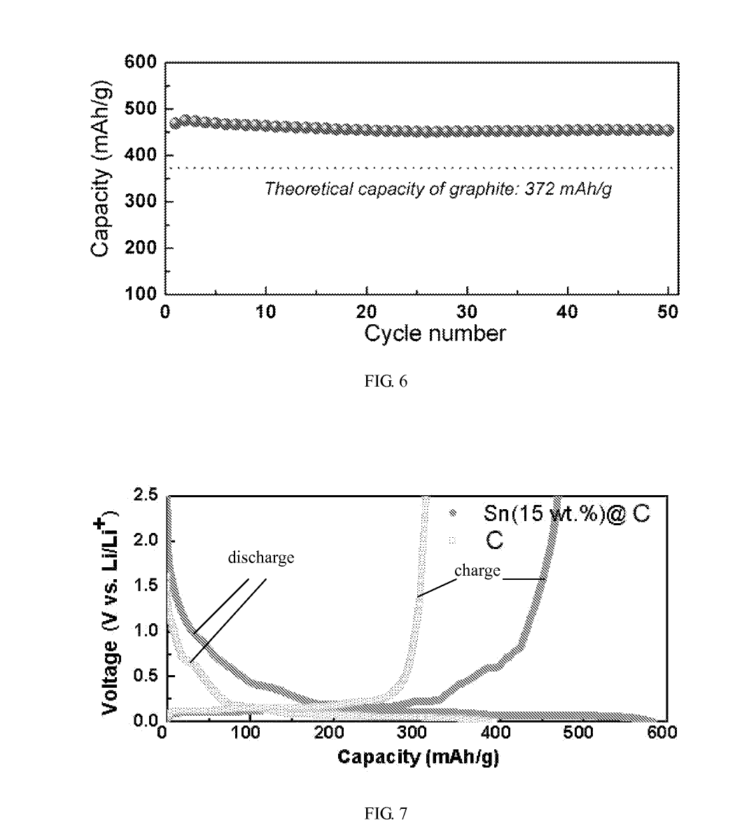

FIG. 6 displays the electrochemical cyclic performance of the composite, in which it can be seen that the Sn@C composite has a very stable cyclability with a reversible capacity of ˜450 mAh/g, which is far more than that (˜340 mAh/g) of the currently used commercial graphite anode material. In addition, it can be seen in FIG. 7 that the composite also has a relatively flat voltage profile with an initial Coulombic efficiency of >80%.

### Comparative Example 2

Natural graphite spheres (0.2 g, average particle size of 20 μm, see FIG. 2a) were added to an aqueous solution of SnCl₂ (6 mL, 0.2 M) to form a precursor solution. After ultrasonic stirring for 30 min., an aqueous solution of ammonia (3.5 mL, 2 wt. %) was added dropwise directly into the precursor solution at room temperature. Afterwards, the precursor solution was filtered, and the collected solid washed with deionized water and further dried at 80° C. in air.

The dried product was subjected to carbothermal reduction in a heating furnace. The temperature of carbothermal reduction was selected to be 950° C. The heating rate of furnace from room temperature to 950° C. was 10° C./min, and N₂ was used as a protective gas atmosphere inside the furnace. After carbothermal reduction for 30 min., the furnace was allowed to cool to room temperature.

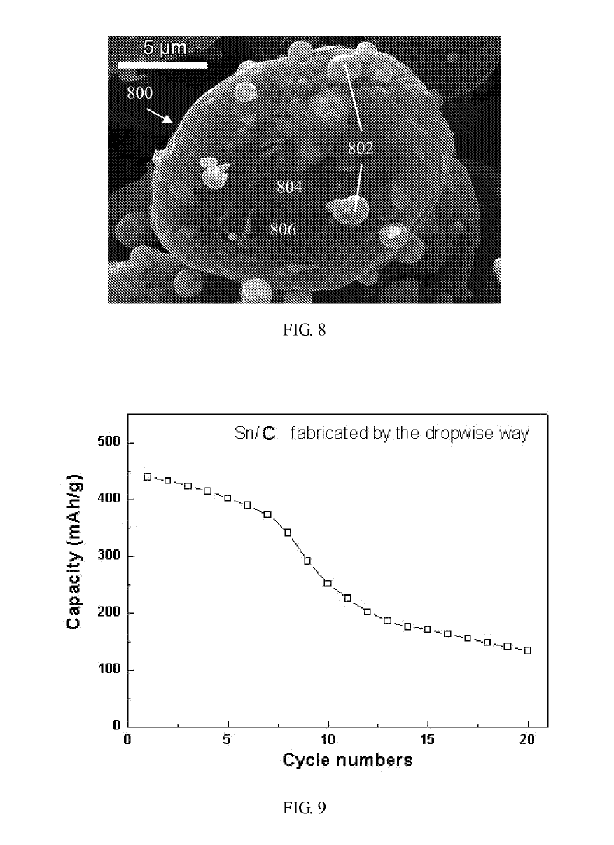

The final product is a Sn/C composite with Sn content of 15 wt. %. It can be seen in FIG. 8 that in this composite [800], formed by direct liquid addition of the catalyst rather than by vapor diffusion, Sn particles [802] of 1-2 μm diameter are non-widely and not thoroughly distributed on the surface [804] of the natural graphite spheres [806], indicating that the dropwise addition of liquid cannot produce the desired well distributed dispersion of Sn particles within the graphite matrix that is obtained by the method of the present invention. Consequently, the Sn/C composite [800] displays a poor electrochemical performance (see FIG. 9).

### Example 3

Natural graphite spheres (1 g) were added to an aqueous solution of SnCl₂ (60 mL, 0.2 M) to form a precursor solution. After ultrasonic stirring for 30 min., the precursor solution [100] was transferred to an open container [102] in a sealed chamber [104], where an aqueous solution of ammonia [106] (2 wt. %) was placed in another separate, open container [108] as shown in FIG. 1. At room temperature, the ammonia vapor [110] gradually diffused [112] into the precursor solution [100] that was under continuous mechanical stirring. After 30 min., the precursor solution [100] was removed from the sealed chamber [104] and filtered. The collected solid was washed with deionized water, and further dried at 80° C. in air.

To perform polymer surface-coating, a portion of the dried product was added to an aqueous solution of PVA polymer (10 ml, 3 wt. %). After stirring at 60° C. for 15 h, the solution was evaporated at 90° C. to obtain the PVA-coated product. This PVA-coated product was subsequently subjected to carbothermal reduction in a heating furnace and simultaneous polymer pyrolysis at 900° C. The heating rate of the furnace from room temperature to 900° C. was 5° C./min, and N₂ was used as a protective gas atmosphere inside the furnace. After carbothermal reduction and polymer pyrolysis for 60 min., the furnace was allowed to cool to room temperature. Analysis confirmed that the final product was a surface-modified Sn@C composite with Sn content of 5 wt. %.

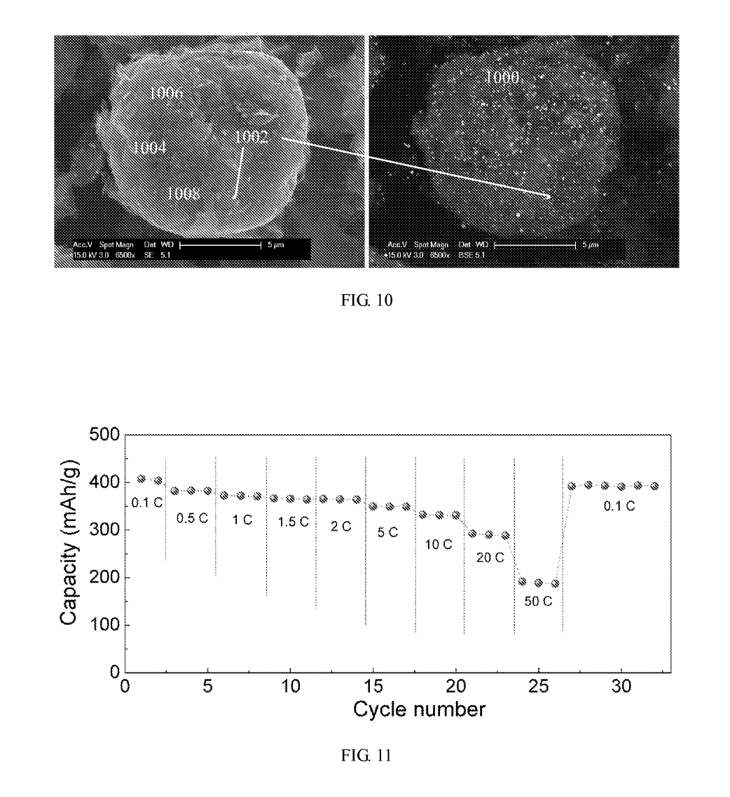

FIG. 10 illustrates a composite material [1000] useful in an anode of a lithium ion battery, comprising metal or metalloid (semi-metal) nanoparticles [1002] distributed widely and thoroughly within a carbon matrix [1004] having a crystalline or porous structure; and further comprising a “polymer-derived carbon” [1006] coated on a surface [1008] of the composite [1000] material to form a surface-modified composite or surface-modified form of the composite material [1000].

FIG. 11 displays the rate capability of the surface-modified composite, in which it can be seen that the composite has excellent high-power performance. Even at 50 C (72 second (s) discharge), a residual capacity of 190 mAh/g is still available.

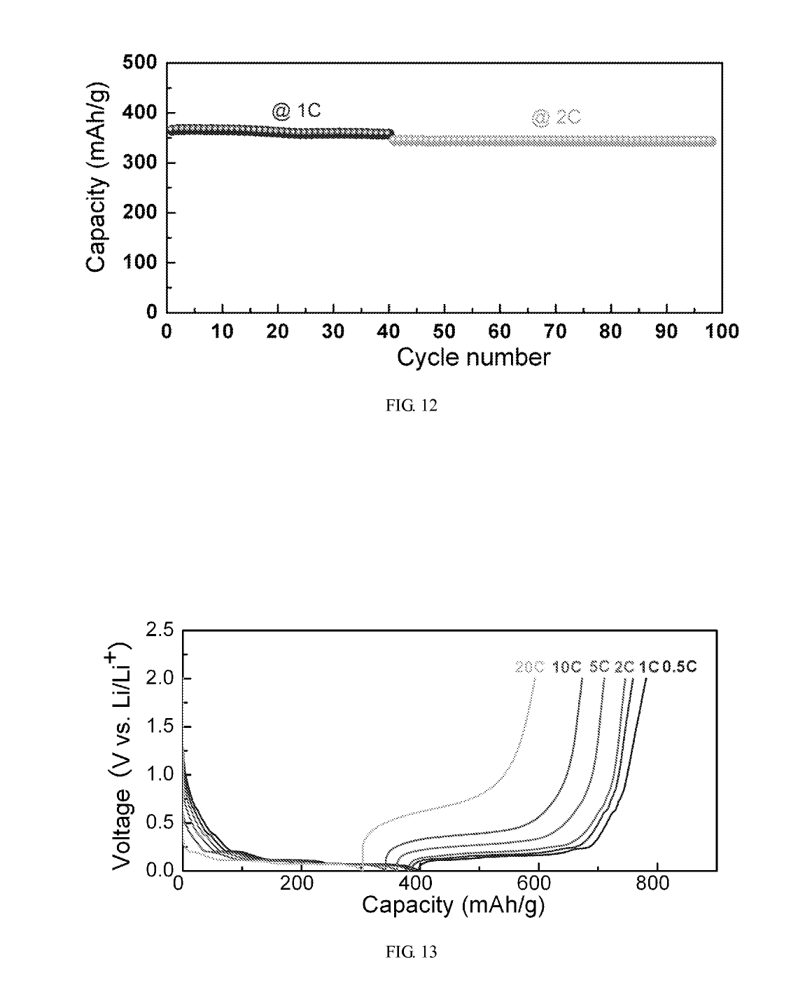

FIG. 12 displays stable cyclability of the surface-modified composite, wherein the data show little or no fading of capacity for 40 cycles at 1 C and for 60 cycles at 2 C.

FIG. 13 displays relatively flat voltage profiles of the surface-modified composite at different C-rates.

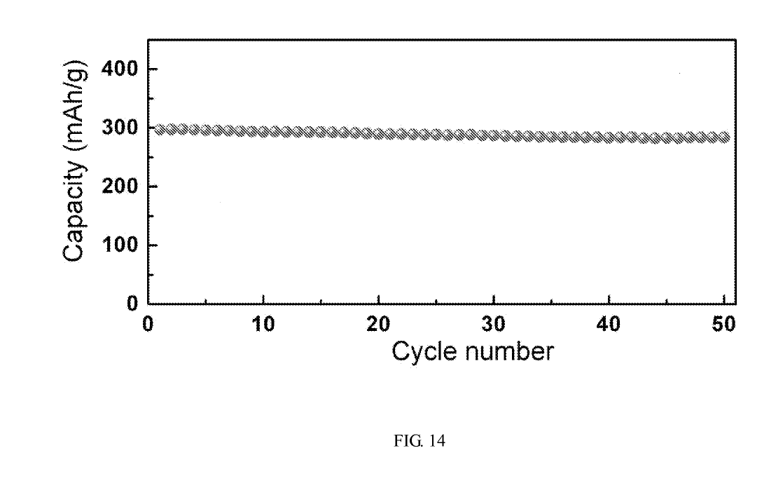

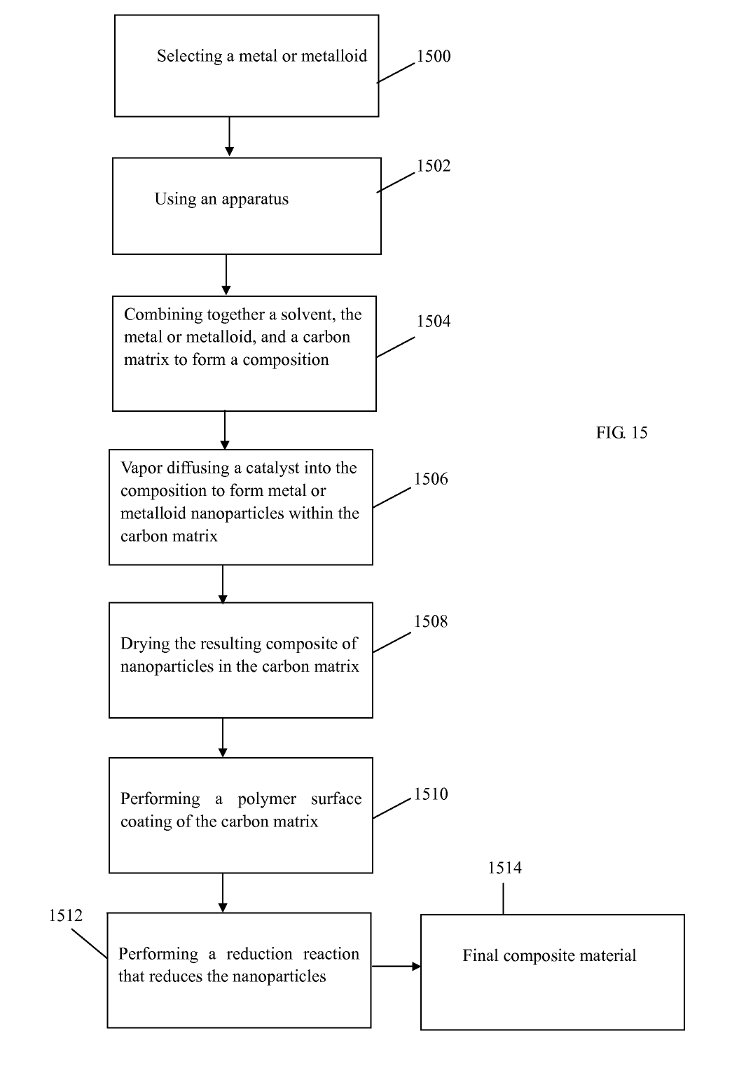

FIG. 14 shows electrochemical cyclic performance of the surface-modified Sn@C composite at the rate of 1 C for both charge and discharge, plotting Capacity (mAh/g) vs. Cycle number.

Process Steps

FIG. 15 illustrates a method for fabricating a composite material useful in an anode of a LIB. The method comprises the following steps.

Block 1500 represents selecting a metal or metalloid (semi-metal) capable of alloying with lithium.

Block 1502 represents using an apparatus to fabricate the composite material. FIG. 1 also illustrates an embodiment of an apparatus for fabricating a composite material useful in an anode of a LIB, comprising: a sealable chamber [104]; a first container [102], inside the sealable chamber [104], for containing a precursor solution or compound, wherein a first opening [114] in the first container [102] is for receiving a vapor diffused catalyst [110]; a second container [108], inside the sealable chamber [104], for containing a catalyst [106], wherein a second opening [116] in the second container [108] is for allowing the catalyst in vapor diffused form [110] to escape from the second container [108]; means (e.g., a pump and pressure sensor) for controlling a pressure in the sealable chamber [104]; means (e.g., one or more heating elements) for controlling a temperature of the sealable chamber [104]; means (e.g., an opening in the first container [102]) for introducing a first solvent and/or additional precursor into the first container [102] and adjusting a concentration of the precursor solution [100]; means (e.g., an opening in the second container [108]) for introducing a second solvent and or additional catalyst into the second container [108] and adjusting a concentration of the catalyst [106]; and means (e.g., a flow meter and fan or pump) for controlling a flow rate of the vapor diffused catalyst [110] in the sealable chamber [104].

Block 1504 represents combining together (i) water, or an organic solvent, or a mixture thereof, (ii) the precursor containing the metal or metalloid (semi-metal) capable of alloying with lithium, wherein the metal or metalloid (semi-metal) is in a precursor compound (e.g., a salt, conjugate, chelate, or molecular complex) capable of reacting in a hydrolysis reaction with the solvent, and (iii) a carbon crystalline, amorphous, or porous structure comprising a carbon matrix, so as to form a composition. The precursor compound may be a salt, conjugate, chelate, or molecular complex of the metal or metalloid (semi-metal), dissolved in the water or the organic solvent, so as to form a precursor solution, and the carbon matrix may be suspended in the precursor solution.

The carbon matrix may comprise, but is not limited to, one or more of the following: natural graphite, synthetic graphite, soft carbon, hard carbon, coke, carbon nanotubes, exfoliated graphite, graphene, chemically treated graphite, carbon nanotubes, graphene, related materials, or a mixture thereof, for example.

Examples of the metals or metalloids (semi-metals) capable of alloying with lithium comprise, but are not limited to, one or more of the following: Sn, Si, Pb, Sb, Ge, Al, Bi, In, Ga, Cd, Zn, As, and Mg. The metal may be Sn and the salt may be SnCl₂, for example. The metalloid may be Si and the precursor compound may be SiCl₄ and/or Si(OC₂H₅)₄, for example.

Block 1506 represents vapor diffusing (vapor diffusion of) a catalyst into the composition, wherein the catalyst is capable of inducing a hydrolysis reaction of the metal or metalloid precursor compound to produce an oxide or oxohydroxide of the metal or metalloid (semi-metal) from the precursor compound, so as to form metal or metalloid (semi-metal) oxide (or oxohydroxide) nanoparticles that grow in situ within the carbon matrix, the nanoparticles thereby becoming well, and/or widely and thoroughly distributed within the carbon matrix. The catalyst may be a molecule comprising catalyst dimensions and properties that enable the molecule to be delivered by vapor diffusion. The catalyst may be (but is not limited to) ammonia or hydrogen chloride, for example. The vapor diffusion may enable the hydrolysis of the precursor solution to cause growth of the metal (or metalloid)-oxide (or -oxohydroxide) nanoparticles, in situ within the carbon matrix, thereby causing the nanoparticles to become well and/or widely and thoroughly distributed within a compliant and conductive carbon matrix.

Controlling the vapor diffusion of the catalyst may enable sufficiently slow growth of the metal (or metalloid)-oxide (or -oxohydroxide) nanoparticles, such that the nanoparticles have dimensions sufficiently small, and a spatial distribution, in order that the nanoparticles become widely and thoroughly distributed throughout the carbon matrix.

The step may further comprise adjusting a concentration of the precursor solution and the catalyst, so that kinetics of both the vapor diffusion of the catalyst and the hydrolysis of the precursor in solution can be modulated to enhance the formation of the metal (or metalloid)-oxide (or -oxohydroxide) nanoparticles well and/or widely and thoroughly distributed within the carbon matrix.

The vapor diffusing step may further comprise placing the precursor solution and the carbon matrix in a first container, and placing the catalyst in a second container separate from the first container, wherein the first container and second container are placed in a closed environment.

The vapor diffusing step may further comprise adjusting a temperature and pressure in the closed environment, and stirring, sonicating, nebulizating (nebulization of), or vibrating the precursor solution, so that the kinetics of both the vapor diffusion of the catalyst and the hydrolysis of the precursor in solution can be modulated to enhance the formation of the metal (or metalloid)-oxide (or -oxohydroxide) nanoparticles well and/or widely and thoroughly distributed within the carbon matrix.

The hydrolysis reaction, catalyzed by the vapor diffusion, may form the metal (or metalloid)-oxide (or -oxohydroxide) nanoparticles with dimensions small enough to penetrate between carbon atomic planes, or the intrinsic (micro, meso or macro) pores, of the carbon matrix.

Block 1508 represents drying the resulting composite of metal (or metalloid)-oxide (or -oxohydroxide) nanoparticles in the carbon matrix.

Block 1510 represents adding an extra process, performing a surface modification of the carbon matrix, by surface-coating the composition with one or more polymers, before performing the carbothermal reduction reaction of Block 1512 below, and performing a polymer pyrolysis, wherein the polymers on the surface of the carbon matrix are pyrolyzed to produce a residual carbon coating on the surface during the subsequent carbothermal reduction of Block 1512, so as to form a surface-modified composite of metal or metalloid (semi-metal) nanoparticles distributed widely within the carbon matrix. Examples of the polymers used for surface modification include, but are not limited to, one or more of the following: polyethylene (PE), polystyrene (PS), polyvinyl alcohol (PVA), polypropylene(PP), polyvinyl chloride(PVC), polyacrylonitrile (PAN), polyvinylpyrrolidone (PVP), and phenol formaldehyde resin (Bakelite), for example.

Block 1512 represents performing a reduction reaction, catalyzed by carbon in the carbon matrix, that reduces the metal or semi-metal of the metal (or semi-metal)-oxide nanoparticles to their corresponding metal or metalloid within the carbon matrix, so as to form a composite of metal or metalloid (semi-metal) nanoparticles well and/or widely and thoroughly distributed within the carbon matrix. The reduction reaction may be performed by carbothermal reduction, by heating the carbon matrix and the metal- (or metalloid) oxide (or oxohydroxide) nanoparticles within the carbon matrix. The carbothermal reduction is performed by heating at a temperature between of 300° C. and 1800° C. The carbothermal reduction may strengthen an interfacial contact between the metal or semi-metal nanoparticles and the carbon matrix.

The two processes of polymer pyrolysis (Block 1510) and the carbothermal reduction reaction (Block 1512) may be completed in one heating step. The one heating step may be heating at a temperature between 300° C. and 1800° C. and may be the same temperature as is used in the carbothermal reduction of Block 1512.

Block 1514 represents the end result of the method, a (e.g., final) composite material [202], [504], useful in an anode of a LIB, as illustrated in FIGS. 2a-2d and 5a-5b, for example, which illustrate metal or metalloid (semi-metal) nanoparticles [204], [500] well and/or widely and thoroughly distributed within a carbon matrix [200], [502] having a crystalline, amorphous, or porous structure; or a surface-modified form of the composite [1000] with “polymer-derived carbon” [1006] coated on the surface [1008]. The nanoparticles [204], [500] may have a diameter less than 500 nanometers.

The interfacial contact between the carbon matrix [200], [502] (e.g., carbon crystal) and the metal or metalloid (semi-metal) nanoparticles [204], [500] of the composite material [202], [504] may be sufficiently strong so that a reversible electrochemical capacity of the anode does not significantly decrease as a number of cycles of charging and discharging of the lithium battery is increased during a lifetime of the battery.

The content of the metal or metalloid (semi-metal) nanoparticles [204], [500] in the composite material [202], [504] may be in the range of 5 to 50 wt. %.

The content of the “polymer-derived carbon” [1006] in the composite material [1000] may be in the range of 2 to 40 wt. %. The surface-modified composite with “polymer-derived carbon” [1006] coated on the surface [1008] may have a core-shell structure comprising a core and a shell. The core may comprise the metal or metalloid (semi-metal) nanoparticles [1002] well and/or widely and thoroughly distributed within the carbon crystalline, amorphous, or porous carbon matrix [1004], and the shell may comprise the “polymer-derived carbon”[1006] on the surface [1008] of the composite material [1000].

The crystalline, amorphous, or porous carbon matrix [200], [502] may be sufficiently resilient or compliant to accommodate a volume change in the metal or semi-metal nanoparticles [204], [500] that results from the metal or semi-metal nanoparticles [204], [500] alloying and de-alloying with lithium during a plurality of charge and discharges of the LIB.

The metal or metalloid [204], [500] may be more widely and thoroughly distributed within the carbon matrix [200], [502] than is achieved using a liquid diffused catalyst method. The nanoparticles [204], [500] may be sufficiently well distributed within the carbon matrix [200], [502] such that a reversible electrochemical capacity of the battery is improved as compared to an electrochemical capacity shown in FIG. 9 (e.g., a reversible electrochemical capacity above ˜340 mAh/g, at least 30% higher than the electrochemical capacity of graphite).

The nanoparticles are typically at least as (or more) widely and thoroughly distributed within the carbon matrix as (or as compared to) the nanoparticles [204], [500], [1002] shown in FIGS. 2a-2d, 5a-5b, or 10. The nanoparticles [204], [500], [1002] typically have a diameter or size less than or equal to the particles [802] shown in FIG. 8, and are at least or more widely and thoroughly distributed within the carbon matrix [200], [502] than the particles [802] shown in FIG. 8. The carbon matrix may be at least as crystalline (or more crystalline) as the crystallinity for Sn@C illustrated in FIG. 4, FIG. 5c or FIG. 5d, for example.

Various embodiments of the present invention may comprise one or more of the above described steps, for example. For example, the present invention may comprise the step of Block 1506 only, the steps of Block 1506 and 1512 only, the steps of Blocks 1500, 1506, and 1512 only, or the steps of Blocks 1500, 1504, 1506, and 1512 only, for example.

The method, composition, and apparatus of the present invention is not limited to use in, or fabrication of, anodes and/or batteries. The present invention may be useful in other applications.

Possible Modifications and Variations

According to the method in the present invention, it is very easy for those in the art to fabricate other composites consisting of lithium-alloying materials (other than Sn) and carbon, such as Pb@C, Zn@C, Sb@C and Si@C, prepared as described above from the precursor solutions of the corresponding metal or metalloid salts, conjugates, chelates, or molecular complexes such as (but not limited to) Pb(NO₃)₂, ZnSO₄, SbCl₂, SiCl₄ and Si(OC₂H₅)₄, etc. The present invention has described Sn@C only as one of the preferred embodiments. The lithium-alloying materials can be metals (Sn, Zn, Mg, etc.) or metalloids (Sb, Si, Ge, etc.).

Advantages and Improvements

The carbon/lithium-alloying material matrix of the present invention is made using vapor diffusion of a catalyst. A vapor-diffusion catalytic synthesis method has been described in U.S. Utility patent application Ser. No. 11/737,087, filed on Apr. 18, 2007, by Daniel E. Morse, Birgit Schwenzer, John R. Gomm, Kristian M. Roth, Brandon Heiken, and Richard Brutchey, and entitled “BIOLOGICALLY INSPIRED SYNTHESIS OF THIN FILMS AND MATERIALS,” which application is incorporated by reference herein. Adapting the method of vapor-diffusion catalysis described in U.S. Utility patent application Ser. No. 11/737,087, the present invention here utilizes the vapor diffusion method to grow tin-oxide (or other metal- or metalloid-oxide) nanoparticles in situ within the compliant graphite spheres (in one embodiment) that serve as a resilient and electrically conductive matrix.

However, vapor diffusion is only a first step of the method of the present invention. In a second step of the present invention, the material is heated, and the carbon of the graphite (or other carbon-based matrix) catalyzes the carbothermal reduction of the tin-oxide to metallic tin nanoparticles. Both the second step and the compliant, conductive, and catalytically reductive carbon are necessary in the present invention. The resulting metallic tin nanoparticles are one active component of the final composite that reversibly “alloys” with lithium, for charging and discharging the battery; the graphite (or other carbon matrix material) is a second active component, that reversibly accepts lithium ions by intercalation, for charging and discharging the battery. The graphite is uniquely resilient or compliant, meaning that it can accommodate the large volume change in the tin particles as they take up the lithium—a volume change that begins to make microcracks in most other electrode materials, leading in those cases to progressive pulverization of the metal (or metalloid) and progressively less and less capacity with each charging and discharging. In the case of the present invention, this resiliency is evidenced by the nearly constant capacity as a function of repeated cycling—the “good cyclability” described above.

The vapor diffusion method of catalyst addition improves on the existing dropwise or bulk liquid addition method. The vapor-diffusion method is absolutely essential for the first step, as supported by data. If, instead, a dropwise or bulk liquid addition of the catalyst is used for the first step, precipitation of the metal-oxide occurs so rapidly that nanoparticles are not formed, and most of the metal oxide precipitated in bulk fails to enter the porous carbon matrix of the graphite. Electrochemical capacity and cyclability of the resulting material formed without using vapor diffusion are very poor and unusable.

The carbon/lithium-alloying material matrix composition is an improvement over existing matrixes produced by traditional methods. Traditionally, graphite alone has been used in Li-ion batteries. The present invention's composite material exhibits a specific electrochemical capacity 30% higher than that of graphite alone. Furthermore, after surface modification, the present invention's composite material exhibits extraordinarily high-power capability, far better than any commercial anodes.

Further information on the present invention can be found in [17,18].

### REFERENCES

The following references are incorporated by reference herein.
[1] J. M. Tarascon, M. Armand, Nature, 2001 (414):359-367.
[2] P. G. Bruce, B. Scrosati, J. M. Tarascon, Angew. Chem. Int. Eg., 2008 (47):2930-2946.
[3] M. Armand, J. M. Tarascon, Nature, 2008 (451):652-657.
[4] H. L. Zhang, C. H. Sun, F. Li, C. Liu, J. Tan, H. M. Cheng, J. Phys. Chem. C, 2007 (111):4740-4748.
[5] J. L. Tirado, Mat. Sci. Eng., R., 2003 (40)103-136.
[6] I. Kim, G. E. Blomgren, P. N. Kumta, Electrochem. Solid-State Lett., 2003 (6):A157-A161.
[7] P. N. Kumta, P. Patel, K. Il-Seok, Mater. Sci. Eng. B, 2005 (116):347-352.
[8] N. Dimov, S. Kugino, M. Yoshio, Electrochim. Acta, 2003 (48):1579-1587.
[9] L. Hong, H. Xuejie, C. Liquan, W. Zhengang, L. Yong, Electrochem. Solid-State Lett., 1999 (2):547-549.
[10] H. Mukaibo, T. Osaka, P. Reale, S. Panero, B. Scrosati, M. Wachtler, J. Power Sources, 2004 (132):225-228.
[11] M. Wachtler, J. O. Besenhard, M. Winter, J. Power Sources, 2001 (94):189-193.
[12] A. Chandra Bosea, D. Kalpanab, P. Thangadurai, S. Ramasamya, J. Power Sources, 2002 (107):138-141.
[13] G. X. Wang, J. H. Ahn, M. J. Lindsay, L. Sun, D. H. Bradhurst, S. X. Dou, H. K. Liu, J. Power Sources, 2001 (97-98):211-215.
[14] J. Y. Lee, R. F. Zhang, Z. L. Liu, J. Power Sources, 2000(90):70-75.
[15] G. X. Wang, J. Yao, J. H. Ahn, H. K. Liu, S. X. Dou, J. Appl. Electrochem., 2004 (34)187-190.
[16] G. Derrien, J, Hassoun, S, panero, B. Scrosati, Adv. Mater. 2007 (19)2336-2340.
[17] Hong-Li Zhang and Daniel E. Morse, “Bio-Inspired, Kinetically Controlled Synthesis of Nanostructured Sn@C Composites for High Energy, High Power Anodes for Lithium Ion Batteries” a poster presented at a conference at the University of California in Santa Barbara, Calif., USA on Feb. 4, 2010.
[18] Hong-Li Zhang and Daniel E. Morse, “Kinetically controlled catalytic synthesis of highly dispersed metal-in-carbon composite and its electrochemical behavior,” J. Mater. Chem., 2009, 19, pages 9006-9011 (2009).

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for fabricating a composite material useful in an anode of a lithium ion battery, comprising:
(a) selecting a metal or metalloid capable of alloying with lithium;
(b) combining together:
(i) water, or an organic solvent, or a mixture thereof,
(ii) the metal or metalloid capable of alloying with lithium, wherein the metal or metalloid is in a precursor compound capable of reacting in a hydrolysis reaction with the water or the organic solvent, and
(iii) a carbon crystalline, amorphous, or porous structure comprising a carbon matrix,
so as to form a composition;
(c) vapor diffusing a catalyst into the composition, wherein the catalyst is capable of inducing the hydrolysis of the metal or metalloid precursor compound to produce an oxide or oxohydroxide of the metal or metalloid from the precursor compound, so as to form metal oxide, metalloid oxide, metal oxohydroxide, or metalloid oxohydroxide nanoparticles that grow in situ within the carbon matrix, the nanoparticles thereby becoming widely and thoroughly distributed within the carbon matrix; and
(d) performing a reduction reaction, catalyzed by carbon in the carbon matrix, that reduces the nanoparticles to their corresponding metal or metalloid within the carbon matrix, so as to form a composite of the nanoparticles distributed widely and thoroughly within the carbon matrix;
so that the composite material useful in an anode of a lithium ion battery is made.

2. The method of claim 1, wherein the reduction reaction is a carbothermal reaction, and further comprising performing a surface modification of the carbon matrix by:
surface-coating the carbon matrix with one or more polymers, before performing the reduction reaction of step (d); and
performing a polymer pyrolysis, wherein the polymers on a surface of the carbon matrix are pyrolyzed to produce a residual carbon coating on the surface during the subsequent carbothermal reduction, so as to form a surface-modified composite of the nanoparticles distributed widely within the carbon matrix.

3. The method of claim 1, wherein the reduction reaction is performed by carbothermal reduction, by heating the carbon matrix and the nanoparticles within the carbon matrix.

4. The method of claim 3, wherein the carbothermal reduction is performed by heating at a temperature between of 300° C. and 1800° C.

5. The method of claim 3, wherein the carbothermal reduction strengthens an interfacial contact between the nanoparticles and the carbon matrix.

6. The method of claim 1, wherein the precursor compound is a salt, conjugate, chelate, or molecular complex of the metal or metalloid, dissolved in the water or the organic solvent so as to form a precursor solution, and the carbon matrix is suspended in the precursor solution.

7. The method of claim 6, wherein the catalyst is a molecule comprising catalyst dimensions and properties that enable the molecule to be delivered by vapor diffusion.

8. The method of claim 6, wherein the catalyst is ammonia or hydrogen chloride.

9. The method of claim 6, wherein the metal is Sn.

10. The method of claim 6, wherein the salt is SnCl₂.

11. The method of claim 6, wherein the metalloid is Si.

12. The method of claim 6, wherein the precursor compound is SiCl₄.

13. The method of claim 6, wherein the precursor compound is Si(OC₂H₅)₄.

14. The method of claim 6, wherein the vapor diffusing of the catalyst enables the hydrolysis of the precursor in solution to cause growth of the nanoparticles, in situ within the carbon matrix, thereby causing the nanoparticles to become widely and thoroughly distributed within a compliant and conductive carbon matrix.

15. The method of claim 14, wherein controlling the vapor diffusing of the catalyst enables a growth of the nanoparticles that is sufficiently slow, such that the nanoparticles have dimensions sufficiently small, and a spatial distribution, in order that the nanoparticles are widely and thoroughly distributed throughout the carbon matrix.

16. The method of claim 14, further comprising drying the nanoparticles and the carbon matrix prior to performing step (d).

17. The method of claim 6, further comprising adjusting a concentration of the precursor solution and the catalyst, so that kinetics of both the vapor diffusing of the catalyst and the hydrolysis of the precursor in solution are modulated to enhance formation of the nanoparticles widely and thoroughly distributed within the carbon matrix.

18. The method of claim 17, wherein the vapor diffusing step further comprises placing the precursor solution and the carbon matrix in a first container and placing the catalyst in a second container separate from the first container, wherein the first container and second container are placed in a closed environment.

19. The method of claim 18, further comprising adjusting a temperature and pressure in the closed environment, and stirring, sonicating, nebulizating, or vibrating the precursor solution, so that kinetics of both the vapor diffusing of the catalyst and the hydrolysis of the precursor in solution are modulated to enhance the formation of the nanoparticles widely and thoroughly distributed within the carbon matrix.

20. The method of claim 1, wherein the hydrolysis reaction, catalyzed by the vapor diffusing, forms the nanoparticles with dimensions small enough to penetrate between carbon atomic planes or intrinsic pores of the carbon matrix.

21. The method of claim 1, wherein the carbon matrix selected from a group including: natural graphite, synthetic graphite, soft carbon, hard carbon, coke, carbon nanotubes, exfoliated graphite, graphene, chemically treated graphite, carbon nanotubes, graphene, related materials, or a mixture thereof.

22. The method of claim 1, wherein the metals or metalloids capable of alloying with lithium are selected from a group including Sn, Si, Pb, Sb, Ge, Al, Bi, In, Ga, Cd, Zn, As, or Mg.

23. The method of claim 2, wherein the polymers used for the surface modification are selected from a group including polyethylene (PE), polystyrene (PS), polyvinyl alcohol (PVA), polypropylene(PP), polyvinyl chloride(PVC), polyacrylonitrile (PAN), polyvinylpyrrolidone (PVP), or phenol formaldehyde resin (Bakelite).

24. The method of claim 2, wherein the polymer pyrolysis and the carbothermal reduction reaction are completed in one heating step.

25. The method of claim 21, wherein the one heating step is at a temperature between 300° C. and 1800° C.

26. A composite material useful in an anode of a lithium ion battery, comprising:
metal or metalloid nanoparticles distributed widely and thoroughly within a carbon matrix having a crystalline, amorphous, or porous structure.

27. The composite material of claim 26, wherein the nanoparticles have a diameter less than 500 nanometers.

28. The composite material of claim 26, wherein an interfacial contact between the carbon matrix and the metal or metalloid nanoparticles of the composite material is sufficiently strong so that a reversible electrochemical capacity of the anode does not significantly decrease as a number of cycles of charging and discharging of the lithium battery is increased during a lifetime of the battery.

29. The composite material of claim 26, wherein a content of the metal or metalloid nanoparticles in the composite material is in a range of 5 to 50 wt. %.

30. The composite material of claim 26, further comprising a “polymer-derived carbon” coated on a surface of the composite material, to form a surface-modified composite or surface-modified form of the composite material.

31. The composite material of claim 30, wherein a content of the “polymer-derived carbon” in the composite material is in a range of 2 to 40 wt. %.

32. The composite material of claim 30, wherein the surface-modified composite with the “polymer-derived carbon” coated on the surface has a core-shell structure.

33. The composite material of claim 32, wherein the core-shell structure comprises a shell and a core, wherein the core comprises the metal or metalloid nanoparticles distributed widely and thoroughly within the crystalline, amorphous, or porous carbon matrix, and the shell comprises the “polymer-derived carbon” on the surface of the composite material.

34. The composite material of claim 26, wherein the crystalline, amorphous, or porous carbon matrix is sufficiently resilient or compliant to accommodate a volume change in the metal or metalloid nanoparticles that results from the metal or metalloid nanoparticles alloying and de-alloying with lithium during a plurality of charge and discharges of the lithium ion battery.

35. An apparatus for fabricating a composite material useful in an anode of a lithium ion battery, comprising:
a sealable chamber;
a first container, inside the sealable chamber, for containing a precursor solution or compound, wherein a first opening in the first container is for receiving a vapor diffused catalyst;
a second container, inside the sealable chamber, for containing a catalyst, wherein a second opening in the second container is for allowing the catalyst in vapor diffused form to escape from the second container;
a pump and pressure sensor, for controlling a pressure in the sealable chamber;
one or more heating elements, for controlling a temperature of the sealable chamber;
an opening in the first container for introducing a first solvent or precursor into the first container and adjusting a concentration of the precursor solution;
an opening in the second container for introducing a second solvent or additional catalyst into the second container and adjusting a concentration of the catalyst; and
a flow meter and fan or pump that controls a flow rate of the vapor diffused catalyst.
